(19) United States
(12) Patent Application Publication
(10) Pub. No.: US 2011/0132826 A1
(43) Pub. Date: Jun. 9, 2011

(54) Block Configuration for Large Scale Membrane Distillation

(75) Inventors: Heinz-Joachim Muller, Woy-Woy (AU); Chan Mya Tun, Baulkham Hills (AU)

(73) Assignee: SIEMENS WATER TECHNOLOGIES CORP., Warrendale, PA (US)

(21) Appl. No.: 13/058,444

(22) PCT Filed: Aug. 13, 2009
(86) PCT No.: PCT/US09/53665

§ 371 Date: Feb. 10, 2011

(30) Foreign Application Priority Data
Aug. 14, 2008 (AU) 2008904172

(51) Int. Cl. B01D 61/36

(52) U.S. Cl. 210/176

(57) ABSTRACT

Embodiments of the present invention seek to provide a membrane distillation system having compact design and simplified connection system for fluid flow paths used in the system. According to one aspect, a membrane distillation system includes at least one membrane module and at least one like configured heat exchanger module, the modules being supported and connected to like configured manifold devices for providing fluid communication between said modules.

### TECHNICAL FIELD

The present invention relates to membrane distillation systems and more particularly to an improved manifold configuration for large-scale membrane distillation systems.

### BACKGROUND OF THE INVENTION

Membrane distillation differs from other distillation techniques such as multi-stage flash, multiple effect distillation and vapour compression in that a non-selective, porous membrane is used. The membrane forms a separation between the warm, vaporising retentate stream and the condensed product, the distillate stream. A suitable choice of membrane material (usually polypropylene, polyethylene or polytetraflorethene) is thus required to ensure the membrane pores are not wetted by the liquid and only vapour passes through the membrane.

Membrane distillation was first described in the mid sixties in an application to improve the efficiency of seawater desalination by the use of an air-filled porous hydrophobic membrane. The method concerned was a so-called direct contact membrane distillation: the warm seawater stream and the cold distillate stream were in direct contact with the membrane.

Interest in membrane distillation became greater in the mid 1980s when a new generation of hydrophobic, highly porous membranes became available.

There are generally considered four types of membrane distillation: 1. Direct contact membrane distillation (DCMD), where both the warm, vaporising stream and the cold condensate stream (distillate stream) are in direct contact with the membrane. 2. Air gap membrane distillation (AGMD), where the condenser surface is separated from the membrane by an air gap. 3. Sweeping gas membrane distillation, where the distillate is removed in vapour form by an inert gas. 4. Vacuum membrane distillation, where the distillate is removed in vapour form by vacuum.

As will be appreciated, each form of distillation system requires various fluid circuits to carry both streams to and from the membrane. This may require complex manifolding systems in large-scale distillation systems.

### DISCLOSURE OF THE INVENTION

The present invention seeks to provide a membrane distillation system having compact design and simplified connection system for fluid flow paths used in the system.

According to one aspect, the present invention provides a membrane distillation system including at least one membrane module and at least one like configured heat exchanger module wherein the modules are supported and connected to like configured manifold devices for providing fluid communication between said modules.

Preferably, the system includes a hot heat exchange module for transferring heated fluid to the membrane module and a cold heat exchange module for cooling fluid from the membrane module. For preference, the heated fluid is provided to a feed side of the membrane module and the fluid to be cooled is provided from a permeate side of the membrane module.

Preferably, each manifold device has a number of fluid communication channels opening into fluid communication ports, wherein the fluid communications ports of one or more manifold devices are in fluid communication with fluid communication ports of one or more other manifold devices to provide for fluid flow therebetween. For preference, one or more of the manifold devices include respective insulation layers. For further preference, the insulation layers are respectively disposed inside the fluid communication channels. For further preference, the manifold devices are block-like in shape and configuration.

Preferably, the modules are arranged in a two dimensional array with like type modules provided in rows of the array. For preference, the module extends between a pair of associated manifold devices. For further preference, the module extends generally vertically between upper and lower manifold devices.

### BRIEF DESCRIPTION OF THE DRAWINGS

A preferred embodiment of the invention will now be described, by way of example only, with reference to the accompanying drawings in which:

FIG. 1 shows a simplified schematic diagram of one form of membrane distillation system which may be used with embodiments of the present invention;

FIG. 2 shows an isometric view of one embodiment of the present invention;

FIG. 3 shows a sectional top view of a filtrate cap which may be used with embodiments of the present invention;

FIG. 4 shows a sectional front view taken on line 4-4 of FIG. 3;

FIG. 5 shows a sectional top view of a manifold including an insulated layer which may be used with embodiments of the present invention; and

FIG. 6 shows a sectional front view taken on line 6-6 of FIG. 5.

### DESCRIPTION OF PREFERRED EMBODIMENTS

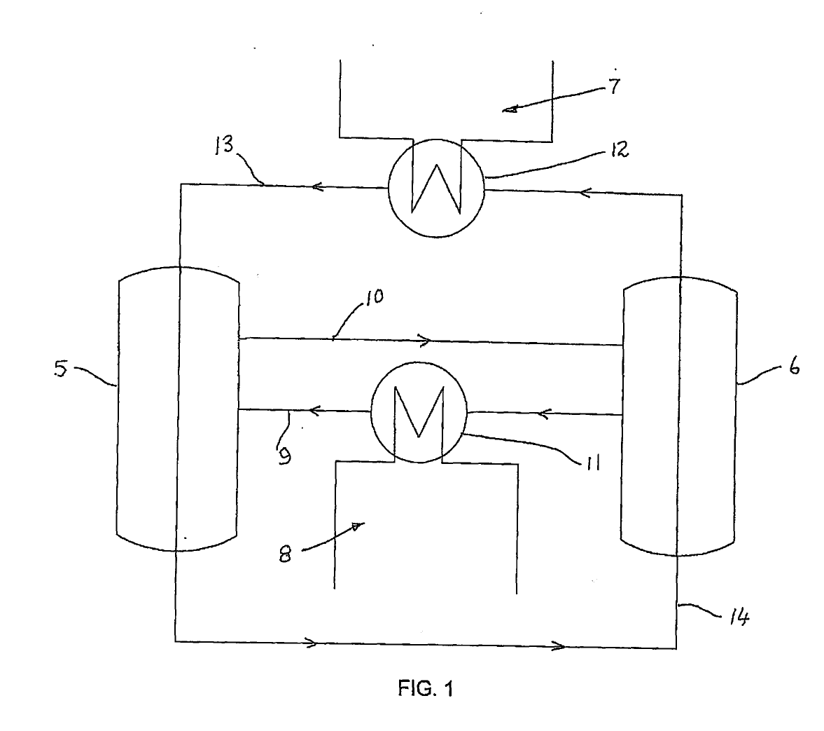

Referring to FIG. 1 there is shown a schematic diagram of a typical membrane distillation system. The system illustrated is a direct contact membrane distillation system where both the warm vaporising stream and the cold condensate stream are in direct contact with the membrane by either flowing through the membrane lumen or along the outside of the membranes. The membranes are hollow fibre membranes arranged in modules, however, it will be appreciated that any form of membrane may be used such as sheet, tubular, plate or mat types. It will be also appreciated that the membranes may be adapted to operate as one of the further forms of membrane distillation system described above, for example, the outer surfaces of the membranes could be separated from the fluid flow by a suitable air-gap.

It will be appreciated that the system is configured for use in both membrane distillation applications and heat exchanger distillation applications. The operating conditions of the two applications deal with heat transfer from hot to cold stream. It will be appreciated, however, that the system is not limited to these two applications.

The system shown comprises a membrane module 5 and a heat recovery heat exchanger module 6 for heat recovery and two heat exchangers 11 and 12 having hot and cold fluid flow circuits 8 and 7, respectively. In the arrangement shown, the liquid on the permeate or filtrate side of the membrane is used as the condensing medium for the vapors leaving the hot feed solution flowing on the feed side of the membrane.

Heat is provided to the hot fluid circuit comprising fluid lines 9 and 10 through heat exchanger 11. The system is cooled by heat exchanger 12 and fluid lines 13 and 14, while heat is recovered from the system through heat exchanger 6.

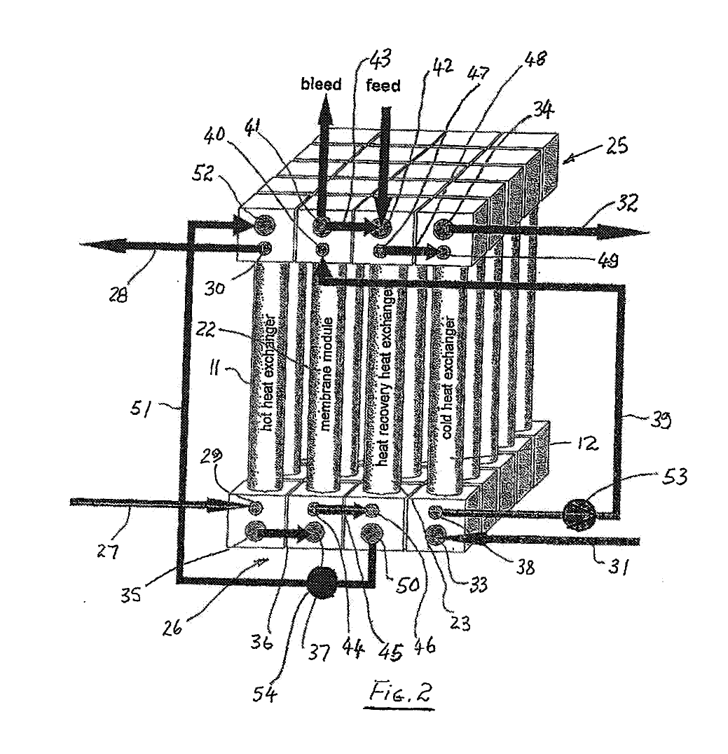

Referring to FIG. 2, one embodiment of the present invention is shown employing a number of modular components. Each module is of similar configuration to enable mounting to a number of like manifold components to control fluid flow between the modules.

The system 20 shown comprises a number of hot heat exchanger components 21, membrane modules 22, heat recovery exchangers 23 and cold heat exchangers 24. Each of the modules is mounted to and extends between upper and lower block-type manifolds 25 and 26 respectively having fluid flow channels therein and ports in fluid communication with the flow channels to provide for the desired fluid flow between the various modules. The manifolds 25 and 26 and modules are arranged in a parallel configuration to provide an overall compact arrangement.

Heat containing fluid is flowed through the hot heat exchanger 11 through fluid lines 27 and 28 which enter through inlet port 29 and exit through outlet port 30. Similarly, cooling fluid is flowed through cold heat exchanger 12 through fluid lines 31 and 32 entering through inlet port 33 and exiting through outlet port 34.

Heated fluid flows from the hot heat exchanger 11 via outlet port 35 and through fluid line 36 into the feed side of the membrane module 22 through inlet port 37. Cooling fluid flows to the permeate side of the membrane module 22 from cold heat exchanger 12 via outlet port 38 and through fluid line 39 into inlet port 40. The heated feed side liquid flows out of the membrane module 22 through outlet port 41 and into the heat recovery heat exchanger 23 inlet port 42 via fluid line 43.

Fluid heated during the condensation process flows out of the membrane module 22 through outlet port 44 through fluid line 45 to the inlet port 46 of the heat recovery heat exchanger 23. The partially cooled fluid then flows out of the heat recovery exchanger 23 through outlet port 47 via fluid line 48 into the cold heat exchanger inlet port 49 for final cooling.

Heat recovered in the heat recovery heat exchanger 23 is returned to the hot heat exchanger 11 by flowing fluid from outlet port 50 through fluid line 51 and into inlet port 52 of the hot heat exchanger 11.

Fluid is circulated through the system using circulation pumps 53 and 54 positioned in fluid lines 39 and 51, respectively.

Feed liquid may be bled from outlet port 41 of the membrane module 22 and added to the system through inlet port 42 of the heat recovery heat exchanger module 23.

The membrane module/s typically comprise a plurality of permeable hollow membranes extending between and supported by a pair of headers. The membranes may be hollow fibres, tubes, flat sheets, plates or mat type membranes.

The heat exchangers may be constructed in a similar manner to the membrane module but using non-permeable fluid transfer devices such as capillaries/fibres, sheets, tubes, plates or mats. The heat exchangers, in at least some embodiments, are constructed using polymeric hollow fibre capillaries.

In some embodiments of the invention, all materials chosen for the polymers withstand the conditions in membrane distillation, such as permanent contact with water and salt water at temperatures between about 10° C. to 100° C. The pressure in some embodiments of the system is kept very low at a level of about +/−20 kPa, around atmospheric pressure.

In other embodiments, the heat exchangers are constructed using metallic materials.

As best shown in FIG. 2, the modular construction enables the system to be arranged in a series of parallel rows of module types each connected via the block type manifold devices. It will be noted the only extensive piping (fluid lines 39, 51) required between the manifolds in each row is from the cold heat exchanger 12 to the membrane module 22 and from heat recovery heat exchanger 23 to the hot heat exchanger 11. This piping provides the advantage of allowing connection to the circulation pumps 53 and 54.

In some embodiments, where the system is used in membrane distillation applications, feed is preheated at a higher temperature than the permeate or filtrate side or cold stream. In other embodiments, where the system is used in heat exchanger applications, the temperature of hot water or low pressure stream is higher than that of the cold stream.

Each of the manifolds 25 and 26, at least in some embodiments, include a filtrate cap 60. In some embodiments, the filtrate cap 60 is disposed inside the manifolds. In other embodiments, the filtrate cap is disposed intermediate respective module ends and manifolds 25 and 26. In further embodiments, filtrate caps are used instead of manifolds.

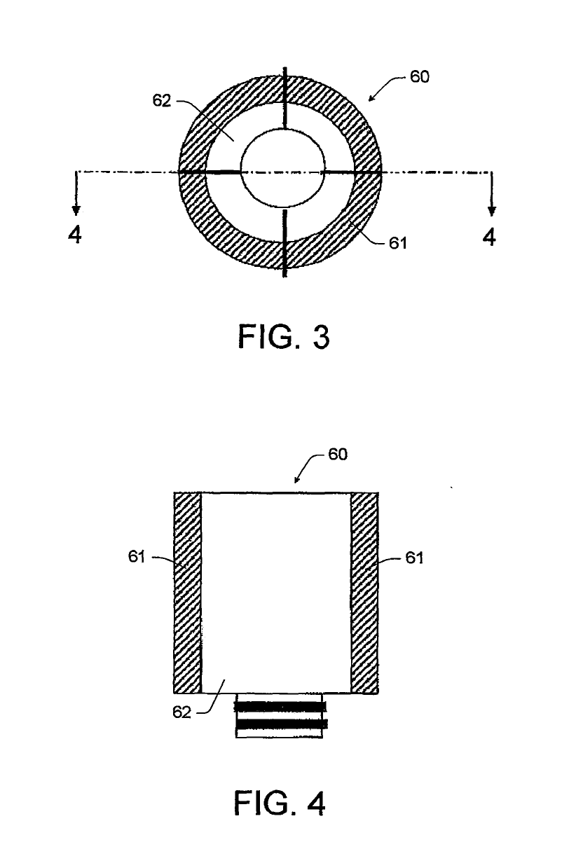

The filtrate cap 60 includes an insulation layer 61, as shown in FIGS. 3 and 4. In some embodiments, the insulation layer 61 is defined integrally by the walls of the filtrate cap, which are formed of a thickness dimension suitable for insulating purposes. In other embodiments, the insulation layer 61 is provided by an insert. This insert, in some embodiments, is a circular tube with a thick insulating wall. An appropriate thickness of the insulation layer 61 depends on the thermal conductivity of the material used. In embodiments of the invention, the material used meets the criteria of the minimum requirement of the permeate or filtrate channel or cold stream channel 62 and the pressure lost.

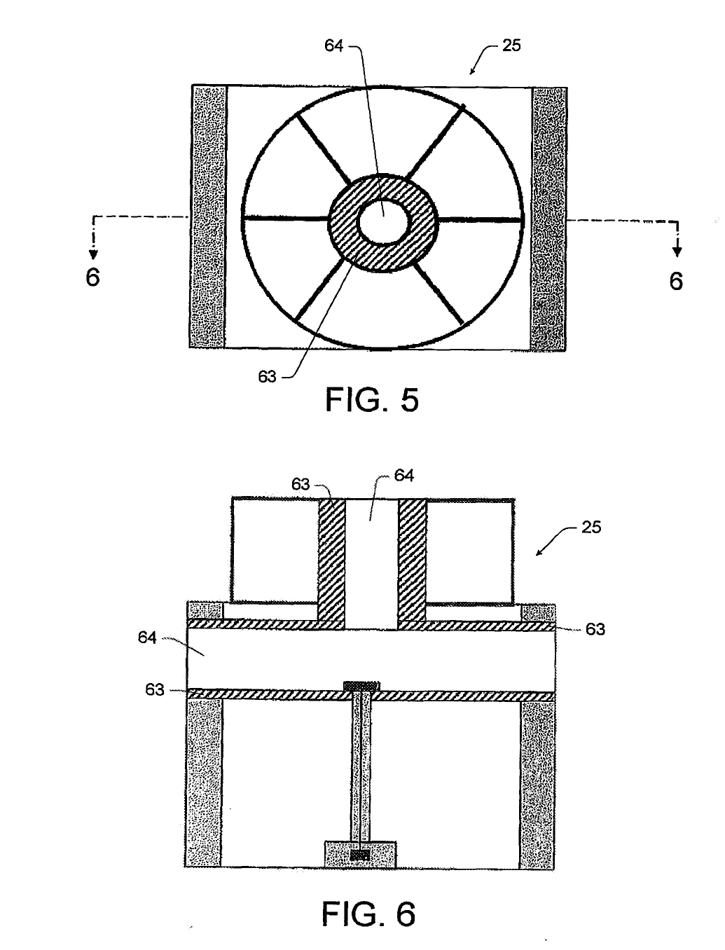

In embodiments of the invention, the manifolds 25 include an insulation layer 63, as shown in FIGS. 5 and 6. In some embodiments, the insulation layer 63 is defined integrally by the walls of flow channels 64, which are formed of a thickness dimension suitable for insulating purposes. In other embodiments, the insulation layer 63 is provided by a separate insert disposed inside the flow channels 64. This insert, in some embodiments, is a circular tube with a thick insulating wall. Although FIGS. 5 and 6 show a particular embodiment of the manifolds 25, it will be appreciated that, at least in some embodiments, the manifolds 26 are substantially identical to the manifolds 25.

Embodiments of the invention utilise the above insulation approaches. In some embodiments, the insulation approach is achieved by utilising filtrate caps 60, which include insulation layer 61. However, it will be appreciated that in other embodiments, the insulation approach is achieved by utilising manifolds 25 and 26, which include insulation layer 63. In further embodiments, the insulation approach is achieved by utilising filtrate caps 60 and manifolds 25 and 26.

In some embodiments, any heat lost due to the conduction heat transfer between the hot and cold streams is prevented or at least minimised by way of the use of insulation approaches, as discussed above. The consequence of this is a saving in the supplied energy and an energy efficient process for applications including membrane distillation and heat exchanger distillation.

The use of a modular construction of like sized and configured modules enables for a compact, easily expandable system. It will be appreciated that the internal surface area of fibres, tubes, plates or the like within the like sized membrane modules and heat exchangers may differ in order to optimize efficiency of the system for particular applications. As fluid flow resistance and surface area are dependent on the dimensions of the fibres, tubes, plates or the like, adjusting these dimensions can be used to optimize fluid flow resistance (pumping costs) and the performance (output) of the system.

It will be appreciated that further embodiments and exemplifications of the invention are possible without departing from the spirit or scope of the invention described.

1. A membrane distillation system comprising at least one membrane module and at least one like configured heat exchanger module, wherein the modules are supported and connected to like configured manifold devices for providing fluid communication between said modules.

2. A system according to claim 1 further comprising a hot heat exchange module for transferring heated fluid to the membrane module and a cold heat exchange module for cooling fluid from the membrane module.

3. A system according to claim 2 wherein the heated fluid is provided to a feed side of the membrane module and the fluid to be cooled is provided from a permeate side of the membrane module.

4. A system according to claim 1 wherein each manifold device defines a number of fluid communication channels opening into fluid communication ports, wherein the fluid communications ports of one or more manifold devices are in fluid communication with fluid communication ports of one or more other manifold devices to provide for fluid flow therebetween.

5. A system according to claim 1 wherein one or more of the manifold devices include respective insulation layers.

6. A system according to claim 5 wherein the insulation layers are respectively disposed inside the fluid communication channels.

7. A system according to claim 1 wherein the manifold devices are block-like in shape and configuration.

8. A system according to claim 1 wherein the modules are arranged in a two dimensional array with like type modules provided in rows of the array.

9. A system according to claim 1 wherein the modules extend between a pair of associated manifold devices.

10. A system according to claim 1 wherein the modules extend generally vertically between upper and lower manifold devices.

11. (canceled)

12. A system according claim 3 wherein each manifold device has a number of fluid communication channels opening into fluid communication ports, wherein the fluid communications ports of one or more manifold devices are in fluid communication with fluid communication ports of one or more other manifold devices to provide for fluid flow therebetween.

13. A system according to claim 4 wherein one or more of the manifold devices include respective insulation layers.

14. A system according to claim 6 wherein the manifold devices are block-like in shape and configuration.

15. A system according to claim 7 wherein the modules are arranged in a two dimensional array with like type modules provided in rows of the array.

16. A system according to claim 8 wherein the module extends between a pair of associated manifold devices.

17. A system according to claim 9 wherein the module extends generally vertically between upper and lower manifold devices.
